(19) United States
(12) Patent Application Publication
(10) Pub. No.: US 2026/0331915 A1
(43) Pub. Date: Oct. 22, 2026

(54) PRE-SYNCHRONIZATION CONTROL METHOD AND SYSTEM FOR GRID CONNECTION OF GRID-FORMING (GFM) CONVERTER BASED ON SECOND-ORDER LINEAR ACTIVE DISTURBANCE REJECTION CONTROL (LADRC)

(71) Applicants: JIANGSU ELECTRIC POWER RESEARCH INSTITUTE CO., LTD., Nanjing (CN); STATE GRID JIANGSU ELECTRIC POWER CO., LTD. RESEARCH INSTITUTE, Nanjing (CN)

(72) Inventors: Wenqiang XIE, Nanjing (CN); Xian ZHENG, Nanjing (CN); Xiaolong XIAO, Nanjing (CN); Juan LI, Nanjing (CN); Jianyu YU, Nanjing (CN); Tiankui SUN, Nanjing (CN); Chenyu ZHANG, Nanjing (CN)

(73) Assignees: JIANGSU ELECTRIC POWER RESEARCH INSTITUTE CO., LTD., Nanjing (CN); STATE GRID JIANGSU ELECTRIC POWER CO., LTD. RESEARCH INSTITUTE, Nanjing (CN)

(21) Appl. No.: 19/337,964

(22) Filed: Sep. 24, 2025

Related U.S. Application Data
(63) Continuation of application No. PCT/CN2025/117736, filed on Aug. 29, 2025.

(30) Foreign Application Priority Data
Apr. 22, 2025 (CN) 202510504041.2

(51) Int. Cl. H02J 3/08; H02J 3/00

(52) U.S. Cl. CPC H02J 3/08; H02J 3/001

(57) ABSTRACT

The provided is a pre-synchronization control method and system for grid connection of a grid-forming (GFM) converter based on second-order linear active disturbance rejection control (LADRC). The pre-synchronization control method includes: deriving a controlled object based on an active power loop of a virtual synchronous generator (VSG); performing inverse Laplace transform on the controlled object; designing the second-order LADRC, including a linear extended state observer (LESO) and a linear state error feedback (LSEF) controller; and performing control adjustment by using a bandwidth w₀ of the LESO and a bandwidth w_{c} of the LSEF controller as adjustment factors, thereby achieving pre-synchronization of the grid connection of the GFM converter. A pre-synchronization control strategy based on the second-order LADRC has advantages of fast synchronization, small voltage and power overshoot, and low dependence on system parameters, and can be applicable to functional requirements in different working scenarios.

### CROSS-REFERENCE TO THE RELATED APPLICATIONS

This application is a continuation application of International Application No. PCT/CN2025/117736, filed on Aug. 29, 2025, which is based upon and claims priority to Chinese Patent Application No. 202510504041.2, filed on Apr. 22, 2025, the entire contents of which are incorporated herein by reference.

### TECHNICAL FIELD

The present disclosure belongs to the field of grids and relates to pre-synchronization control for grid connection of a grid-forming (GFM) converter, and specifically, to a pre-synchronization control method and system for grid connection of a GFM converter based on second-order linear active disturbance rejection control (LADRC).

### BACKGROUND

A grid-forming converter serves as an interface for connecting a distributed microgrid to a grid, and its grid-connection control strategy, directly affects stable operation of the grid. Currently, grid-forming (GFM) converters primarily employ virtual synchronous generator (VSG) control to provide inertia and damping for grids. However, if the distributed microgrid is directly grid-connected via closing, it may cause significant voltage impact to the grid. Main pre-synchronization control currently includes phase-locked loop (PLL)-based pre-synchronization control and coordinate transformation-based pre-synchronization control.

The PLL-based pre-synchronization control obtains a voltage difference and a phase angle difference between a grid side and a converter outlet, and feeds the voltage difference and the phase angle difference into active and reactive power loop controllers of the VSG for secondary adjustment. However, it takes a certain amount of time for a PLL to start and achieve stability, which affects a pre-synchronization speed of a system.

The coordinate transformation-based pre-synchronization control achieves error-free tracking of a voltage of the grid through a proportional-integral (PI) controller, thereby avoiding an adverse impact caused by a cumbersome operation of the PLL. However, the coordinate transformation-based pre-synchronization control relies heavily on system parameters and requires a large amount of computation, which necessitates a high-performance digital processor, thereby increasing the hardware cost.

Therefore, in existing pre-synchronization control of a converter, it is impossible to simultaneously meet two requirements of “low dependency on the system parameters” and “fast synchronization”.

Therefore, there is a need to propose a new technical solution to solve the problem.

### SUMMARY

### Technical Objective

To overcome the shortcomings in the prior art, a pre-synchronization control method and system for grid connection of a GFM converter based on second-order LADRC are provided, which solve problems of high dependence on system parameters and slow synchronization in existing pre-synchronization control.

### Technical Solution

To achieve the above objective, the present disclosure provides a pre-synchronization control method for grid connection of a GFM converter based on second-order LADRC, including following steps:
S1: deriving a controlled object based on an active power loop of a VSG;
S2: performing inverse Laplace transform on the controlled object;
S3: designing the second-order LADRC, including a linear extended state observer (LESO) and a linear state error feedback (LSEF) controller, where
the LESO is configured to observe an output and a total disturbance of a controlled system and provide the output and the total disturbance to the LSEF controller; and
the LSEF controller is configured to control an input of the controlled system based on a system reference value and observed data provided by the LESO, and feed error data back to the LESO; and
S4: performing control adjustment by using a bandwidth w₀ of the LESO and a bandwidth w_{c} of the LSEF controller as adjustment factors, thereby achieving pre-synchronization of the grid connection of the GFM converter.

Furthermore, an expression of the controlled object in the step S1 is as follows:

$$\{ \begin{matrix}{G}_{ω - Δω} = \frac{{K}_{D}}{J {ω}_{n} {s}^{2} + ( {K}_{p} + D ) s + {K}_{D}} \\ {K}_{D} = \frac{EU}{X}\end{matrix}$$

where ω represents a current system angular frequency, Δω represents a difference between the current angular frequency and a reference angular frequency, ωₙ represents a rated angular frequency, J represents a moment of inertia, D represents a damping coefficient, E represents a voltage on a grid side, U represents a voltage on an outlet side of a converter, X represents impedance between the converter and the grid side, s represents a complex frequency component, which is obtained through Laplace transform, Kₚ represents a droop coefficient of the active power loop, G_{ω-Δω} represents a transfer function for inputting the Δω and outputting the ω, and K_{D} represents a variable value.

Furthermore, in the step S2, the inverse Laplace transform is performed on the controlled object to obtain that:

$$\frac{{d}^{2} ω}{{dt}^{2}} = \frac{{K}_{D}}{J {ω}_{n}} Δω - \frac{{k}_{p} + D}{J {ω}_{n}} \frac{d ω}{dt} + \frac{{K}_{D}}{J {ω}_{n}} ω$$

where t represents time; thus, it is proved that converting an s-domain into a time domain is applicable to second-order active disturbance rejection control.

Furthermore, the LESO in the step S3 includes three observation points z₁, z₂, and z₃, and three gain coefficients β₁, β₂, and β₃, the z₁ is configured to observe the output y of the system, the z₂ is configured to observe a differential of the output y, the z₃ is configured to observe the total disturbance of the system, and the three gain coefficients β₁, β₂, and β₃ are configured to estimate and compensate for an uncertain dynamic of the system in real time.

Furthermore, the LESO in the step S3 is expressed as follows:
writing the controlled object as ÿ=−a₁\dot{y}−a₂y+w+bu; and defining f(y,\dot{y},w)=−a₁\dot{y}−a₂y+w+(b−b₀)u as the total disturbance of the system, where u and y respectively represent the input and the output of the system respectively, \dot{y} represents a derivative of the output y, w represents an external disturbance, a₁ represents a damping characteristic of a control system for a change rate of the output y, a₂ reflects a recovery characteristic of the output y towards an equilibrium state, b represents a gain coefficient of an impact of the input on a system state, and b₀ represents an estimated value of the b; and
defining following state variables:

$$\{ \begin{matrix}{x}_{1} = y \\ {x}_{2} = \dot{y} \\ {x}_{3} = f ( y , \dot{y} , w ) \\ h = \dot{f} ( y , \dot{y} , w )\end{matrix}$$

where x₁ represents the output y, x₂ represents the derivative of the output y, x₃ represents the total disturbance of the system, and h represents a derivative of the total disturbance of the system; and
the corresponding LESO is as follows:

$$\{ \begin{matrix}\dot{z} = ( A - LC ) z + [ B , L ] {u}_{c} \\ \hat{y} = Cz\end{matrix}$$

where u_{c}=[u y]^{T} represents a combined input of the LESO, L=[β₁ β₂ β₃]^{T} represents an observer error feedback gain matrix that needs to be designed,

$$A = [ \begin{matrix}0 & 1 & 0 \\ 0 & 0 & 1 \\ 0 & 0 & 0\end{matrix} ] ,$$

B=[0 b 0]^{T}, C=[0 0 1]^{T}, z represents an observed value of x, ż represents a derivative of the z, and ŷ represents an observed value of the output y.

Furthermore, the LSEF controller in the step S3 observes a state differential signal through tracking differentiator (TD) control, where a TD control law is as follows:

u₀=kₚ(v−z₁)−kₐz₂
where kₚ and k_{d} respectively represent a proportional gain coefficient and a differential gain coefficient of the LSEF controller, and v represents a given reference value of the system.

Furthermore, design and operation of the bandwidth w_{c} of the LSEF controller in the step S4 include:

when the system is stable, performing z₂→\dot{y}, and calculating a closed-loop transfer function for the input and the output:

$$\frac{y ( s )}{r ( s )} = \frac{{k}_{p}}{{s}^{2} + {k}_{d} s + {k}_{p}} = \frac{{w}_{c}^{2}}{{( s + {w}_{c} )}^{2}} = \frac{{w}_{c}^{2}}{{s}^{2} + 2 {w}_{c} s + {w}_{c}^{2}}$$

where y(s) represents the output, and r(s) represents a value of a reference input r after the Laplace transform; and
selecting, through

$${k}_{p} = {w}_{c}^{2}$$

and k_{d}=2w_{c}, a pole placement for designing the LSEF controller, such that the system is stable through the selection of the pole placement.

Furthermore, design and operation of the bandwidth w₀ of the LESO in the step S4 include:

λ(s)=|sI−(A−LC)|=s³+β₁s²+β₂s+β₃=(s+ω₀)³
where λ(s) represents a characteristic polynomial of the above equation, and I represents an identity matrix; and
after parameterization, configuring a pole of the LESO on the bandwidth w₀, and obtaining that:

$$\{ \begin{matrix}{β}_{1} = 3 {ω}_{0} \\ {β}_{2} = 3 {ω}_{0}^{2} \\ {β}_{3} = {ω}_{0}^{2}\end{matrix}$$

In the present disclosure, a method for performing the control adjustment by using the bandwidth w_{c} of the LSEF controller and the bandwidth w₀ of the LESO as the adjustment factors is as follows:

Firstly, the bandwidth w_{c} is adjusted to enable the system to quickly converge to a desired state, thereby avoiding voltage overshoot and enhancing stability of the system.

Secondly, a dynamic change of the system is rapidly captured through the bandwidth w₀, so as to promptly track an unknown disturbance, accelerate pre-synchronization of a microgrid, and reduce dependence on system parameters.

Thirdly, the w_{c} and the w₀ are adjusted in real time based on different working condition changes, so as to optimize control performance.

The present disclosure further provides a pre-synchronization control system for grid connection of a GFM converter based on second-order LADRC, including:
a controlled-object establishment module configured to derive a controlled object and perform inverse Laplace transform;
a LADRC design module configured to design the second-order LADRC, including an LESO and an LSEF controller; and
a pre-synchronization module configured to perform control adjustment by using a bandwidth w₀ of the LESO and a bandwidth w_{c} of the LSEF controller as adjustment factors, thereby achieving pre-synchronization of the grid connection of the GFM converter.

A pre-synchronization control strategy based on the second-order LADRC in the present disclosure has advantages of fast synchronization, small voltage and power overshoot, and low dependence on system parameters, and can be applicable to functional requirements in different working scenarios.

### Beneficial Effects

Compared with the prior art, the present disclosure has the following advantages:
1. The present disclosure designs an extended state observer to estimate and compensate for an unknown disturbance and an uncertain dynamic of a system in real time, thereby achieving higher robustness during operation.
2. The method in the present disclosure can directly control an input and an output of a controlled system, without a need for complex parameter tuning. This reduces deterioration of control performance caused by inaccurate parameters and enhances operational reliability of the system.
3. The present disclosure provides a rapid state observation and feedback mechanism, completing a pre-synchronization process for a distributed microgrid in an extremely short time.
4. In the present disclosure, pre-synchronization control based on LADRC utilizes an adaptive parameter adjustment mechanism and does not require communication for data transmission. Therefore, when a converter is connected to a grid, an output voltage and a frequency can be quickly synchronized with those of the grid.

### BRIEF DESCRIPTION OF THE DRAWINGS

FIG. 1 is a schematic diagram of a pre-synchronization control strategy based on LADRC;

FIG. 2 is a control block diagram of second-order LADRC;

FIG. 3 shows a simulation system for grid connection of a single distributed microgrid;

FIG. 4 shows active powers of a converter under different control strategies in a working condition 1;

FIG. 5 shows reactive powers of a converter under different control strategies in a working condition 1;

FIG. 6 shows voltage data of a converter under different control strategies in a working condition 1;

FIGS. 7A and 7B show timing sequences for pre-synchronization control under different strategies in a working condition 1;

FIG. 8 shows active powers under different control strategies in a working condition 2;

FIG. 9 shows reactive powers under different control strategies in a working condition 2;

FIG. 10 shows voltage data of a converter under different control strategies in a working condition 2; and

FIGS. 11A and 11B show timing sequences for pre-synchronization control under different strategies in a working condition 2.

### DETAILED DESCRIPTION OF THE EMBODIMENTS

The following further describes the present disclosure with reference to the accompanying drawings and specific embodiments. It should be understood that these embodiments are only used to illustrate the present disclosure, not to limit the scope of the present disclosure. Various equivalent modifications made to the present disclosure by those skilled in the art after reading the present disclosure shall fall within the scope defined by the appended claims of the present disclosure.

### Embodiment 1

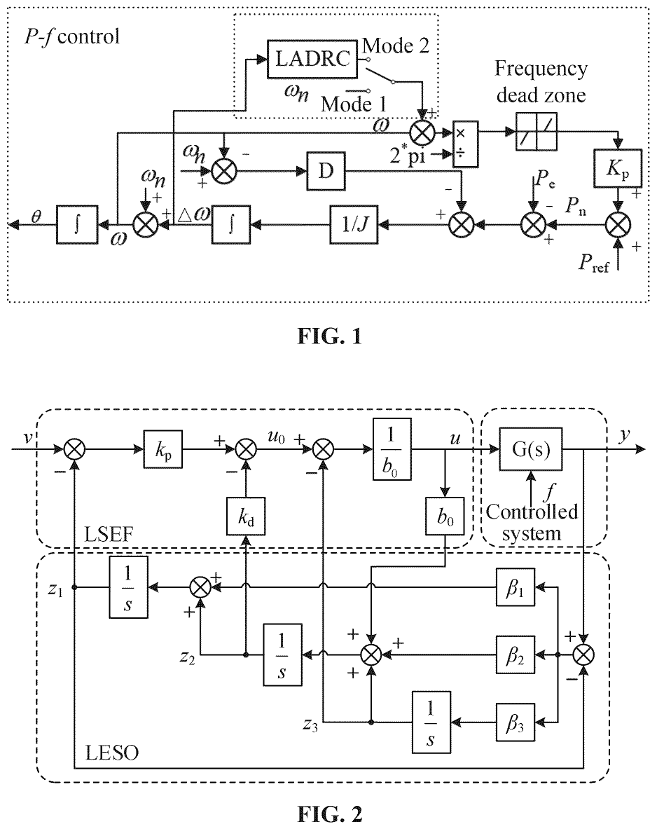

This embodiment provides a pre-synchronization control method for grid connection of a GFM converter based on second-order LADRC, including the following steps:
S1: Referring to FIG. 1, a controlled object is derived by using a Mason formula based on an active power loop of a VSG, and is expressed as follows:

$$\{ \begin{matrix}{G}_{ω - Δω} = \frac{{K}_{D}}{J {ω}_{0} {s}^{2} + ( {K}_{p} + D ) s + {K}_{D}} \\ {K}_{D} = \frac{EU}{X}\end{matrix}$$

where ω represents a current system angular frequency, Δω represents a difference between the current angular frequency and a reference angular frequency, ωₙ represents a rated angular frequency, J represents a moment of inertia, D represents a damping coefficient, E represents a voltage on a grid side, U represents a voltage on an outlet side of a converter, X represents impedance between the converter and the grid side, s represents a complex frequency component, which is obtained through Laplace transform, Kₚ represents a droop coefficient of the active power loop, G_{ω-Δω} represents a transfer function for inputting the Δω and outputting the ω, K_{D} represents a variable value, ∫ represents an integral, Pₑ represents an electromagnetic power of the converter, Pₙ represents a rated frequency, P_{ref} represents a reference frequency, and pi represents a pi parameter.
S2: Inverse Laplace transform is performed on the controlled object to obtain that:

$$\frac{{d}^{2} ω}{{dt}^{2}} = \frac{{K}_{D}}{{J ω}_{n}} Δω - \frac{{K}_{p} + D}{{J ω}_{n}} \frac{d ω}{dt} + \frac{{K}_{D}}{{J ω}_{n}} ω$$

where t represents time; thus, it is proved that converting an s-domain into a time domain is applicable to second-order active disturbance rejection control.

S3: The second-order LADRC is designed, including an LESO and an LSEF controller.

The LESO is configured to observe an output and a total disturbance of a controlled system and provide the output and the total disturbance to the LSEF controller.

The LSEF controller is configured to control an input of the controlled system based on a system reference value and observed data provided by the LESO, and feed error data back to the LESO.

As shown in FIG. 2, f represents an external disturbance, and G(s) represents a transfer function. The LESO includes three observation points z₁, z₂, and z₃, and three gain coefficients β₁, β₂, and β₃. The z₁ is configured to observe the output y of the system, the z₂ is configured to observe a differential of the output y, the z₃ is configured to observe the total disturbance of the system, and the three gain coefficients β₁, β₂, and β₃ are configured to estimate and compensate for an uncertain dynamic of the system in real time.

The LESO is expressed as follows:

The controlled object is written as ÿ=−a₁\dot{y}−a₂y+w+bu; and f(y, \dot{y},w)=−a₁\dot{y}−a₂y+w+(b−b₀)u is defined as the total disturbance of the system, where u and y respectively represent the input and the output of the system respectively, \dot{y} represents a derivative of the output y, w represents an external disturbance, a₁ represents a damping characteristic of a control system for a change rate of the output y, a₂ reflects a recovery characteristic of the output y towards an equilibrium state, b represents a gain coefficient of an impact of the input on a system state, and b₀ represents an estimated value of the b.

Following state variables are defined:

$$\{ \begin{matrix}{x}_{1} = y \\ {x}_{2} = \dot{y} \\ {x}_{3} = f ( y , \dot{y} , w ) \\ h = \dot{f} ( y , \dot{y} , w )\end{matrix}$$

where x₁ represents the output y, x₂ represents the derivative of the output y, x₃ represents the total disturbance of the system, and h represents a derivative of the total disturbance of the system.

$$\{ \begin{matrix}\dot{x} = A x + B u + E h \\ y = C x\end{matrix}$$

$$A = [ \begin{matrix}0 & 1 & 0 \\ 0 & 0 & 1 \\ 0 & 0 & 0\end{matrix} ] ,$$

B=[0 b, 0]^{T}, E=[0 0 1]^{T}, and C=[1 0 0]^{T}.

The corresponding LESO is as follows:

$$\{ \begin{matrix}\dot{z} = ( A - L C ) z + [ B , L ] {u}_{c} \\ \hat{y} = C z\end{matrix}$$

where u_{c}=[u y]^{T} represents a combined input of the LESO, L=[β₁ β₂ β₃]^{T} represents an observer error feedback gain matrix that needs to be designed, z represents an observed value of x, ż represents a derivative of the z, and ŷ represents an observed value of the output y.

The LSEF controller observes a state differential signal through TD control, where a TD control law is as follows:

u₀=kₚ(v−z₁)−k_{d}z₂
where kₚ and k_{d} respectively represent a proportional gain coefficient and a differential gain coefficient of the LSEF controller, and v represents a given reference value of the system.

S4: Control adjustment is performed by using bandwidth w₀ of the LESO and bandwidth w_{c} of the LSEF controller as adjustment factors, thereby achieving pre-synchronization of the grid connection of the GFM converter.

Design and operation of the bandwidth w_{c} of the LSEF controller include:

When the system is stable, z₂→\dot{y} is performed, and a closed-loop transfer function for the input and the output is calculated:

$$\frac{y ( s )}{r ( s )} = \frac{{k}_{p}}{{s}^{2} + {k}_{d} s + {k}_{p}} = \frac{{w}_{c}^{2}}{{( s + {w}_{c} )}^{2}} = \frac{{w}_{c}^{2}}{{s}^{2} + 2 {w}_{c} s + {w}_{c}^{2}}$$

where y(s) represents the output, and r(s) represents a value of reference input r after the Laplace transform.

A pole placement for designing the LSEF controller is selected through

$${k}_{p} = {w}_{c}^{2}$$

and k_{d}=2w_{c}, such that the system is stable through the selection of the pole placement.

Design and operation of the bandwidth w₀ of the LESO include:

According to a modern control theory, when an eigenvalue of (A-LC) is less than 0, a system error will converge to 0 as time increases.

λ(s)=|sI−(A−LC)|=s³+β₁s²+β₂s+β₃=(s+ω₀)³
where λ(s) represents a characteristic polynomial of the above equation, and I represents an identity matrix.

After parameterization, a pole of the LESO is configured on the bandwidth w₀, and it is obtained that:

$$\{ \begin{matrix}{β}_{1} = 3 {ω}_{0} \\ {β}_{2} = 3 {ω}_{0}^{2} \\ {β}_{3} = {ω}_{0}^{2}\end{matrix}$$

A method for performing the control adjustment by using the bandwidth w_{c} of the LSEF controller and the bandwidth w₀ of the LESO as the adjustment factors is as follows:

Firstly, the bandwidth w_{c} is adjusted to enable the system to quickly converge to a desired state, thereby avoiding voltage overshoot and enhancing stability of the system.

Secondly, a dynamic change of the system is rapidly captured by setting the bandwidth w₀ of the LESO to a large value, so as to promptly track an unknown disturbance, accelerate pre-synchronization of a microgrid, and reduce dependence on system parameters.

Thirdly, the w_{c} and the w₀ are adjusted in real time based on different working condition changes, so as to optimize control performance.

### Embodiment 2

Based on the pre-synchronization control method provided in Embodiment 1, this embodiment provides a pre-synchronization control system for grid connection of a GFM converter based on second-order LADRC, including:
a controlled-object establishment module configured to derive a controlled object and perform inverse Laplace transform;
a LADRC design module configured to design the second-order LADRC, including an LESO and an LSEF controller; and
a pre-synchronization module configured to perform control adjustment by using bandwidth w₀ of the LESO and bandwidth w_{c} of the LSEF controller as adjustment factors, thereby achieving pre-synchronization of the grid connection of the GFM converter.

### Embodiment 3

In order to verify effectiveness and performance of the solution in the present disclosure, a following simulation experiment is conducted:

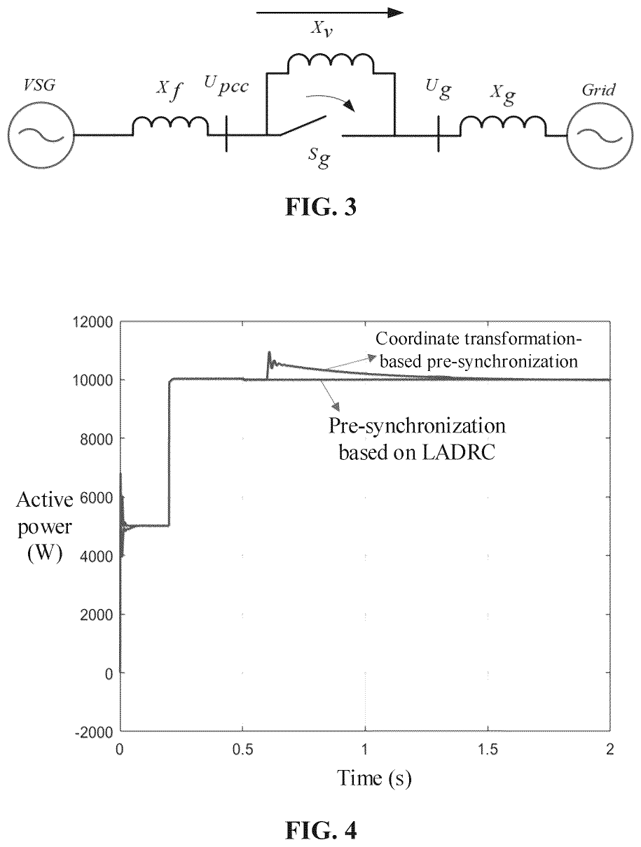

As shown in FIG. 3, a simulation system for grid connection of a single distributed microgrid is constructed. Herein, X_{f} represents impedance on a converter side, U_{pcc} represents a voltage of a common coupling point, X_{V} represents impedance between a converter and a grid side, P_{V} represents an active power transmitted from the converter to a grid, Q_{V} represents a reactive power transmitted from the converter to the grid, U_{g} represents a voltage on the grid side, X_{g} represents impedance on the grid side, VSG represents a virtual synchronous generator, Grid represents the grid, and S_{g} represents a grid-connection closing switch.

A parameter setting in a simulation process is shown in Table 1. Herein, C_{f} represents capacitance on the converter side.

TABLE 1
Simulation parameters

| Parameter | Value | Parameter | Value |
|---|---|---|---|
| U_{PCC}/V | 800 | U_{g}/V | 380 |
| X_{f}/mH | 2 | C_{f}/uF | 20 |
| X_{g}/mH | 0.2 | wₙ/(rad · s⁻¹) | 2 × π × fₙ |
| J/(kg · m²) | 3.333 | D/(N · m · s · rad⁻¹) | 30 |
| fₙ/Hz | 50 | w₀/(rad/s) | 500 |
| w_{c}/(rad/s) | 100 | b₀ | 5.5 |

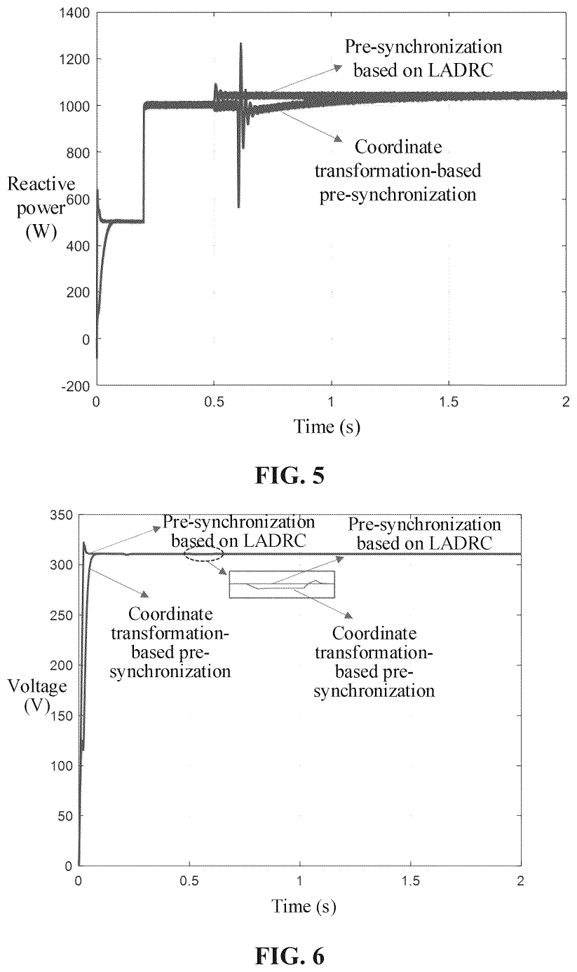

Working condition 1: When the distributed microgrid operates in an islanded mode with a load of 5 KW/0.5 k Var, an active power reference value increases by 10 KW and a reactive power reference value increases by 1 kVar when the system operates for 0.2 s. A pre-synchronization closing signal is sent to the system at 0.5 s. Total simulation time for the system is 2 s, and simulation waveforms are shown in FIG. 4 to FIGS. 7A and 7B.

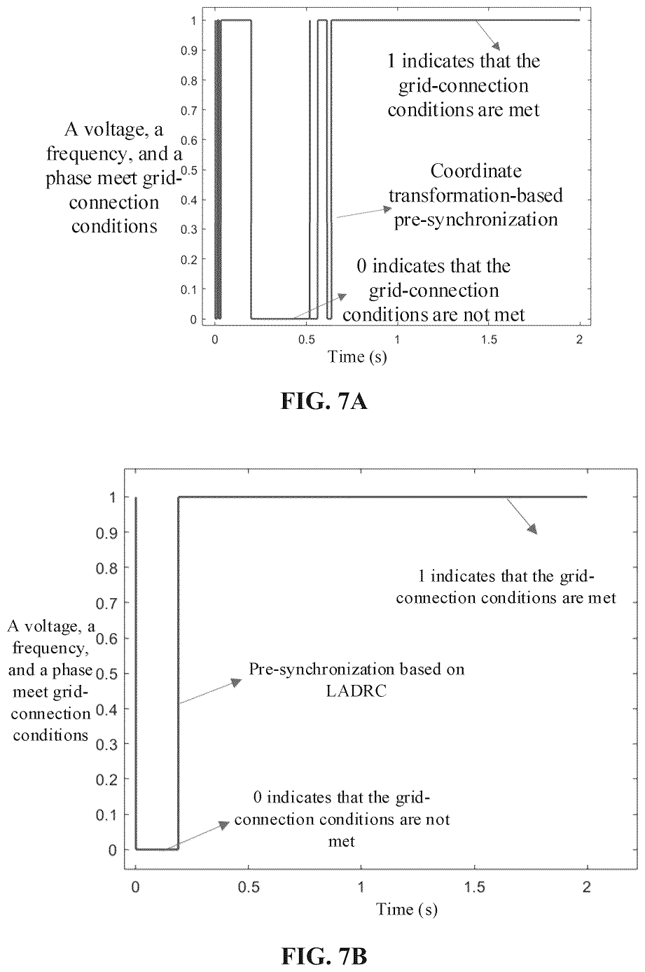

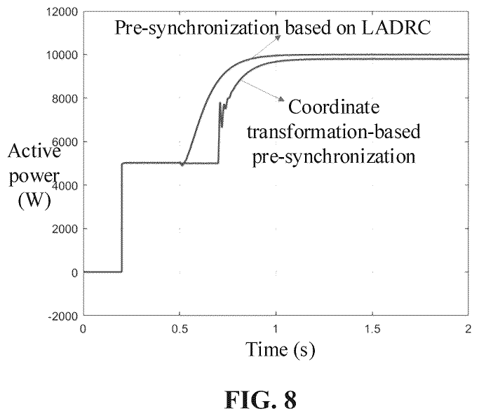

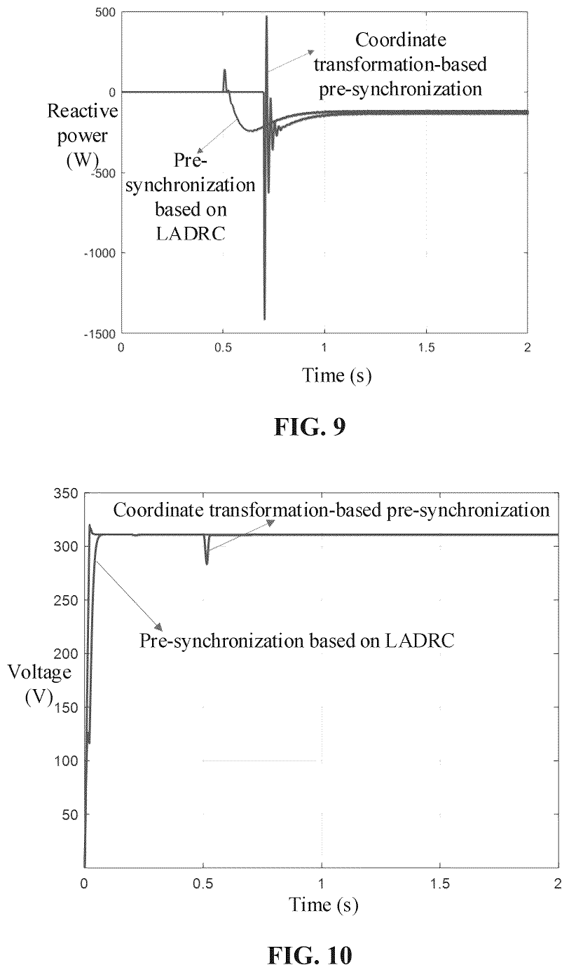

From FIG. 4 to FIG. 6, it can be seen that within a transitional period of pre-synchronous closing at 0.5 s, an active power, a reactive power, and a voltage at an outlet of the converter in pre-synchronization based on second-order LADRC experience a significantly smoother transition than those in coordinate transformation-based pre-synchronization, with no significant impact. FIGS. 7A and 7B show that the pre-synchronization based on the second-order LADRC is noticeably faster than the coordinate transformation-based pre-synchronization.
Working condition 2: When the distributed microgrid operates in the islanded mode, the load suddenly increases by 5 kW at 0.2 s. The pre-synchronization closing signal is sent to the system at 0.5 s, with an active power reference value of 10 kW. The total simulation time for the system is 2 s, and the simulation waveforms are shown in FIG. 8 to FIGS. 11A and 11B.

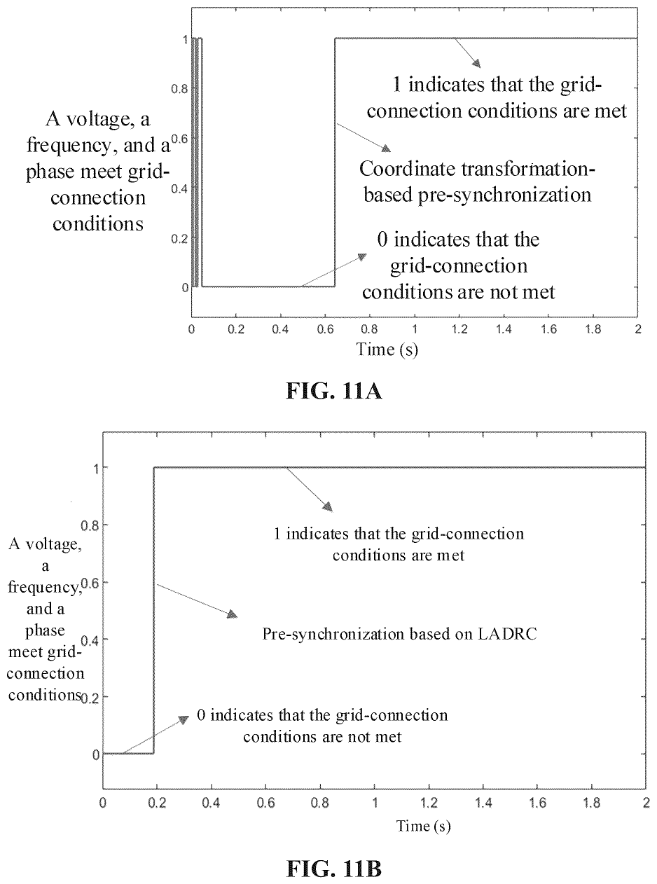

From FIG. 8 to FIG. 10, it can be seen that a deviation of an active power output in the pre-synchronization based on the second-order LADRC is only 0.1%, while a deviation of an active power output in the coordinate transformation-based pre-synchronization is 2.37%. Moreover, at a closing moment, a power and a voltage in the pre-synchronization based on the second-order LADRC experience a relatively smooth transition. FIGS. 11A and 11B show that pre-synchronization control based on the second-order LADRC quickly meets a requirement for pre-synchronization grid connection.

In summary, the pre-synchronization control strategy based on the second-order LADRC in the present disclosure not only shortens grid-connection closing time of the converter and reduces voltage and power impact at the closing moment, but also significantly reduces an impact of an external disturbance on operational stability of the system and reduces dependence on system parameters, thereby providing a strong guarantee for reliable grid connection of the distributed microgrid.

1. A pre-synchronization control method for grid connection of a grid-forming (GFM) converter based on second-order linear active disturbance rejection control (LADRC), comprising following steps:
S1: deriving a controlled object based on an active power loop of a virtual synchronous generator (VSG);
S2: performing inverse Laplace transform on the controlled object;
S3: designing the second-order LADRC, comprising a linear extended state observer (LESO) and a linear state error feedback (LSEF) controller, wherein
the LESO is configured to observe an output and a total disturbance of a controlled system and provide the output and the total disturbance to the LSEF controller; and
the LSEF controller is configured to control an input of the controlled system based on a system reference value and observed data provided by the LESO, and feed error data back to the LESO; and
S4: performing control adjustment by using a bandwidth w₀ of the LESO and a bandwidth w_{c} of the LSEF controller as adjustment factors, wherein pre-synchronization of the grid connection of the GFM converter is achieved;
wherein an expression of the controlled object in the step S1 is as follows:
$$\{ \begin{matrix}{G}_{ω - Δω} = \frac{{K}_{D}}{{J ω}_{n} {s}^{2} + ( {K}_{p} + D ) s + {K}_{D}} \\ {K}_{D} = \frac{EU}{X}\end{matrix}$$
wherein ω represents a current system angular frequency, Δω represents a difference between the current system angular frequency and a reference angular frequency, ωₙ represents a rated angular frequency, J represents a moment of inertia, D represents a damping coefficient, E represents a voltage on a grid side, U represents a voltage on an outlet side of a converter, X represents impedance between the converter and the grid side, s represents a complex frequency component, Kₚ represents a droop coefficient of the active power loop, G_{ω-Δω} represents a transfer function for inputting the Δω and outputting the ω, and K_{D} represents a variable value;
wherein in the step S2, the inverse Laplace transform is performed on the controlled object to obtain that:
$$\frac{{d}^{2} ω}{{dt}^{2}} = \frac{{K}_{D}}{{J ω}_{n}} Δω - \frac{{K}_{p} + D}{{J ω}_{n}} \frac{d ω}{dt} + \frac{{K}_{D}}{{J ω}_{n}} ω$$
wherein t represents time.

2. The pre-synchronization control method for the grid connection of the GFM converter based on the second-order LADRC according to claim 1, wherein the LESO in the step S3 comprises three observation points z₁, z₂, and z₃, and three gain coefficients β₁, β₂, and β₃, the z₁ is configured to observe the output y of the system, the z₂ is configured to observe a differential of the output y, the z₃ is configured to observe the total disturbance of the system, and the three gain coefficients β₁, β₂, and β₃ are configured to estimate and compensate for an uncertain dynamic of the system in real time.

3. The pre-synchronization control method for the grid connection of the GFM converter based on the second-order LADRC according to claim 2, wherein the LESO in the step S3 is expressed as follows:
writing the controlled object as ÿ=−a₁\dot{y}−a₂y+w+bu; and defining f(y, \dot{y}, w)=−a₁\dot{y}−a₂y+w+(b−b₀)u as the total disturbance of the system, wherein u and y respectively represent the input and the output of the system respectively, \dot{y} represents a derivative of the output y, w represents an external disturbance, a₁ represents a damping characteristic of a control system for a change rate of the output y, a₂ reflects a recovery characteristic of the output y towards an equilibrium state, b represents a gain coefficient of an impact of the input on a system state, and b₀ represents an estimated value of the b; and
defining following state variables:
$$\{ \begin{matrix}{x}_{1} = y \\ {x}_{2} = \dot{y} \\ {x}_{3} = f ( y , \dot{y} , w ) \\ h = \dot{f} ( y , \dot{y} , w )\end{matrix}$$
wherein x₁ represents the output y, x₂ represents the derivative of the output y, x₃ represents the total disturbance of the system, and h represents a derivative of the total disturbance of the system; and
the corresponding LESO is as follows:
$$\{ \begin{matrix}\dot{z} = ( A - L C ) z + [ B , L ] {u}_{c} \\ \hat{y} = C z\end{matrix}$$
wherein u_{c}=[u y]^{T} represents a combined input of the LESO, L=[β₁ β₂ β₃]^{T} represents an observer error feedback gain matrix that needs to be designed,
$$A = [ \begin{matrix}0 & 1 & 0 \\ 0 & 0 & 1 \\ 0 & 0 & 0\end{matrix} ] ,$$
B=[0 b 0]^{T}, C=[0 0 1]^{T}, z represents an observed value of x, ż represents a derivative of the z, and ŷ represents an observed value of the output y.

4. The pre-synchronization control method for the grid connection of the GFM converter based on the second-order LADRC according to claim 3, wherein the LSEF controller in the step S3 observes a state differential signal through tracking differentiator (TD) control, wherein a TD control law is as follows:
u₀=kₚ(v−z₁)−k_{d}z₂
wherein kₚ and k_{d} respectively represent a proportional gain coefficient and a differential gain coefficient of the LSEF controller, and v represents a given reference value of the system.

5. The pre-synchronization control method for the grid connection of the GFM converter based on the second-order LADRC according to claim 4, wherein design and operation of the bandwidth w_{c} of the LSEF controller in the step S4 comprise:
when the system is stable, performing z₂→\dot{y}, and calculating a closed-loop transfer function for the input and the output:
$$\frac{y ( s )}{r ( s )} = \frac{{k}_{p}}{{s}^{2} + {k}_{d} s + {k}_{p}} = \frac{{w}_{c}^{2}}{{( s + {w}_{c} )}^{2}} = \frac{{w}_{c}^{2}}{{s}^{2} + 2 {w}_{c} s + {w}_{c}^{2}}$$
wherein y(s) represents the output, and r(s) represents a value of a reference input r after Laplace transform; and
selecting, through
$${k}_{p} = {w}_{c}^{2}$$
and k_{d}=2w_{c}, a pole placement for designing the LSEF controller, wherein the system is stable through selection of the pole placement.

6. The pre-synchronization control method for the grid connection of the GFM converter based on the second-order LADRC according to claim 5, wherein design and operation of the bandwidth w₀ of the LESO in the step S4 comprise:
λ(s)=|sI−(A−LC)|=s³+β₁s²+β₂s+β₃=(s+ω₀)³
wherein λ(s) represents a characteristic polynomial of the above equation, and I represents an identity matrix; and
after parameterization, configuring a pole of the LESO on the bandwidth w₀, and obtaining that:
$$\{ \begin{matrix}{β}_{1} = 3 {ω}_{0} \\ {β}_{2} = 3 {ω}_{0}^{2} \\ {β}_{3} = {ω}_{0}^{2}\end{matrix} .$$
